(19) United States
(12) Patent Application Publication
(10) Pub. No.: US 2011/0038074 A1
(43) Pub. Date: Feb. 17, 2011

(54) Ramp for a hard disc drive

(75) Inventors: Stephen Ralph Viskochil, Los Gatos, CA (US); Mark Spencer Seymour, Felton, CA (US)

Correspondence Address: SAILE ACKERMAN LLC, 28 DAVIS AVENUE, POUGHKEEPSIE, NY, 12603, US

(73) Assignee: SAE Magnetics (HK) Ltd.

(21) Appl. No.: 12/583,252

(22) Filed: Aug. 17, 2009

(51) Int. Cl. G11B 21/02

(52) U.S. Cl. 360/75; G9B/21.003

(57) ABSTRACT

A moveable ramp arrangement having a traditional front side while the back side has an extended rotational park position used to support the read/write heads while the ramp is in the open position before and during disc installation.

### BACKGROUND OF THE INVENTION

(1) Technical Field

The present invention relates generally to hard disc drives (HDD), and more particularly to improving ramp load/unload apparatus involving a mechanism for safely positioning read/write heads.

(2) Description of the Prior Art

Present-day mass produced hard disc drives consists of a metallic housing in which is contained one or more discs (platters) mounted on a spindle that allows the discs to rotate. The discs are made from a solid, non-magnetic material, normally aluminum or glass. The discs are coated, on each side, with a very thin layer of magnetic material into which information is stored in binary form. For both sides of each disc there is a read/write head mounted on a suspension arm that moves across the surfaces of each disc.

Typically, HDDs employ a rotary actuator structure to position the suspension arm(s) transducer heads relative to recording surfaces of rotating discs. The discs are spun at high speed that spins the air creating an “air bearing effect” on the disc surface enabling an aerodynamically shaped read/write head to “float” at a very controlled gap from the magnetic surface of the platter. This gap is extremely small, measuring less than the diameter of a human hair. Assembly of many precision made mechanical parts along with the construction of hard discs is done in a clean room and humidity-controlled environment to prevent contamination that may cause very serious damage to the hard disc.

For the past several years, data storage methods have followed a tendency of escalating storage capacity while also shrinking the physical size occupied by its storage capacities. Introduction of more powerful computer hardware and software has contributed to increasing market pressures for less expensive, larger capacity and smaller packaging in disc drives. Storage device manufacturers make every effort to achieve any possible incremental cost savings that can be reasonably achieved without loss of technical performance and reliability.

HDDs, of the prior art, using a ramp, involve a mechanism which moves the sliders off the discs prior to power-down, and safely positions them onto a cam-like structure. The cam is equipped with a shallow ramp on the side closest to the disc, giving ramp load/unload its name. During a power-on sequence, the read/write heads are loaded by moving the sliders off the ramp, and over the disc surfaces when the discs reach the appropriate rotational speed. The air current from the rotating disc acts like an air cushion between the sliders and discs, keeping the two surfaces separated by a designed distance, called the flying height.

Conventionally, installed ramps are on the base of the metallic housing. The ramps either slide or rotate into position over the surfaces of each disc. This action requires a precision-machined reference surface, a locating stop and a securing feature in the base. Additionally, HDDs using a latch to prevent the read/write heads from moving onto platter surfaces during shipping or non-operating situations, are installed on the base keeping the actuator in a secure position in the event of inappropriate handling. This also requires a precise machined mounting surface, locating stop and a securing feature on the base. Lastly, a flexible printed circuit (FPC) used to transfer data from a read/write head to a printed circuit board (PCB). A connector is used to electrically join the PCB that is mounted outside the sealed disc drive to the FPC, which is attached to the read/write heads inside the sealed disc drive. A gasket provided to seal the connector, and a bracket to locate and compress the gasket. This also requires a precise machined mounting surface, locating features and a securing feature in the base. Conventionally, the ramp, latch and connector bracket are three separate members attached and positioned independently onto the base structure.

Traditionally, hard disk drives that use a ramp will load the read/write heads from the backside of the ramp opposite the disc side. This action requires additional travel to the backside of the ramp for loading the actuator assembly. Because of the additional travel, the coil side of the actuator is made smaller to allow clearance for installing discs. The smaller coil size affects efficiency of the actuator. During disc loading, the actuator must be held off the ramp. After loading the discs, the ramp is then positioned over the disc, the head separator comb removed, and the actuator loaded onto the ramp. The stop for the outside diameter position is then installed after the actuator is loaded on the ramp. With all this activity, exposure to disc damage is a real possibility that would necessitate the entire disc drive to be reworked.

### SUMMARY OF THE INVENTION

An object of the present invention is to provide an improved ramp device for parking read/write heads in hard disc drives. The improvement permitting loading the heads from the front side of the ramp thereby reducing head travel during loading while yielding more space on the coil side to provide more room for a more efficient voice coil motor. Moreover, the outside diameter stop can be put into place before the actuator and discs are installed. The actuator can also be placed on the ramp while in the park position, and the head comb removed before the discs are installed. The only remaining action required after disc installation is to rotate and to secure the ramp in position to reduce possible disc damage.

Another object of the present invention is to provide a ramp with a rotational pivot aligned to the head's actuator pivot while in the parked position.

Still another object of the present invention is to continue the ramp's park position, rotationally, on the same radius allowing the read/write heads to be installed from the front (disc) side.

Yet another object of the present invention is to reduce disc damage and to make the assembly tooling less complicated.

Still another object of the present invention is to fixably attach the outside diameter stop to the base for more accurate positioning.

A novel application of geometric design principles is at the center of the present invention. Applying these, principles while integrating parts serve the assembly and improve reliability for the hard disc drive.

The foregoing, together with other object features and advantages of this invention, can be better appreciated with reference to the following specification, claims, and the accompanying drawings.

### BRIEF DESCRIPTION OF THE DRAWINGS

FIG. 1 is a schematic of a hard disc drive showing a ramp of the prior art.

FIG. 2 is perspective view of a hard disk drive with an elevated view of a connector bracket assembly of the invention.

FIG. 3 is a perspective view of the connector bracket of the invention.

FIG. 4 is a perspective view of a ramp of the invention.

FIG. 5 is a perspective view of the connector bracket assembly of the invention.

FIG. 6 is a top view of the ramp before snapping into claws of the invention.

FIG. 7 is a top view of the ramp snapped into claws of the invention.

FIG. 8 is a top view of the invention of a hard disc drive showing the actuator in a position close to the ID.

FIG. 9 is a top view of a hard disc drive showing the actuator rotated clockwise to the OD park position, of the invention.

FIG. 10 is a top view of a hard disc drive showing the ramp-rotated counter-clockwise into the closed position over the disc, of the invention.

FIG. 11 is an enlarged perspective view of the ramp, of the invention.

### DETAILED DESCRIPTION OF THE PREFERRED EMBODIMENT

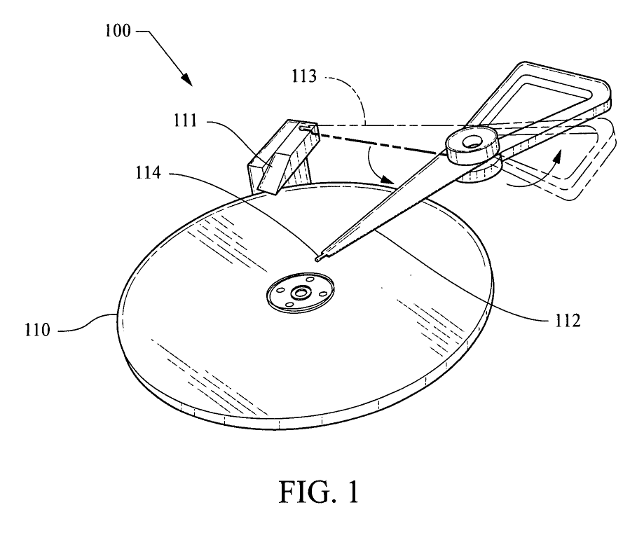

FIG. 1 illustrates a schematic of a ramp 111 for a hard disk drive 100, of the prior art, with a suspension head slider in a park position 113. The suspension head rotates into a read/write mode 112 as the rotating disc 110 provides an air bearing effect as the read/write head slider 114 floats over the disc surface.

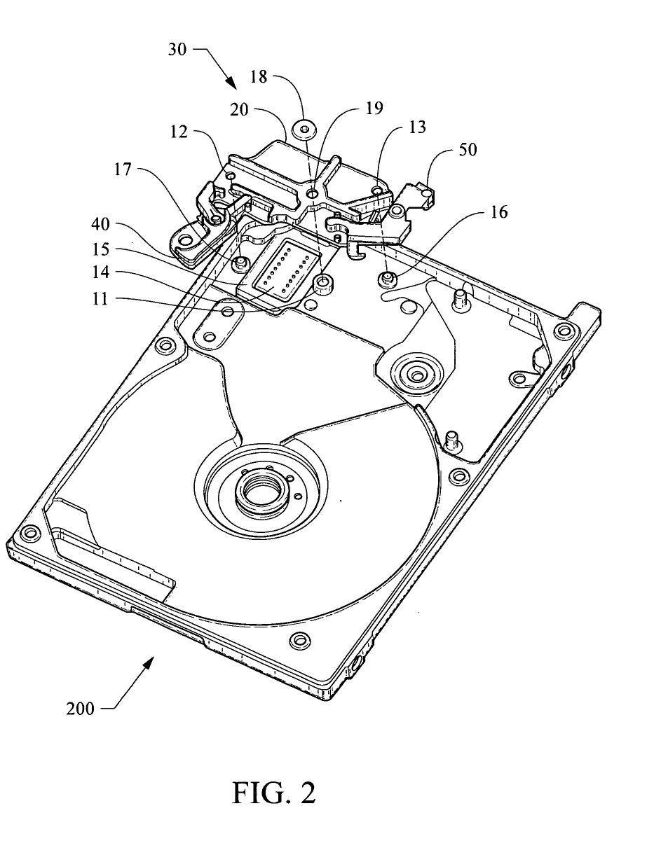

FIG. 2 illustrates a perspective top view of a hard disk drive 200 showing the top surface of a connector bracket assembly 30. The assembly includes a demountable ramp device 40 and a demountable latch member 50, of the invention. Assembly 30 is shown raised for clarity. The connector bracket 20 includes two alignment holes 12, 13 extending from the top to its bottom surface. The two alignment holes are positioned to fit over two locating pins 16, 17, protruding up from the base of the hard disk drive 200. The locating pins are used to position the bracket assembly 30 to compress gasket 15. The gasket surrounds connector 14. A flexible printed circuit (not shown) is used to transfer data from the read/write head to the printed circuit board. The connector 14 electrically interconnects to a printed circuit board (not shown) that is mounted outside the sealed disc drive to a flexible printed circuit that is attached to the read/write heads inside the sealed disc drive. The connector bracket assembly 30 is demountably secured to base 200 with mounting screw 18 inserted through a clearance hole 19 centrally disposed through a rib section and fastened to the base by a threaded member 11 while compressing gasket 15.

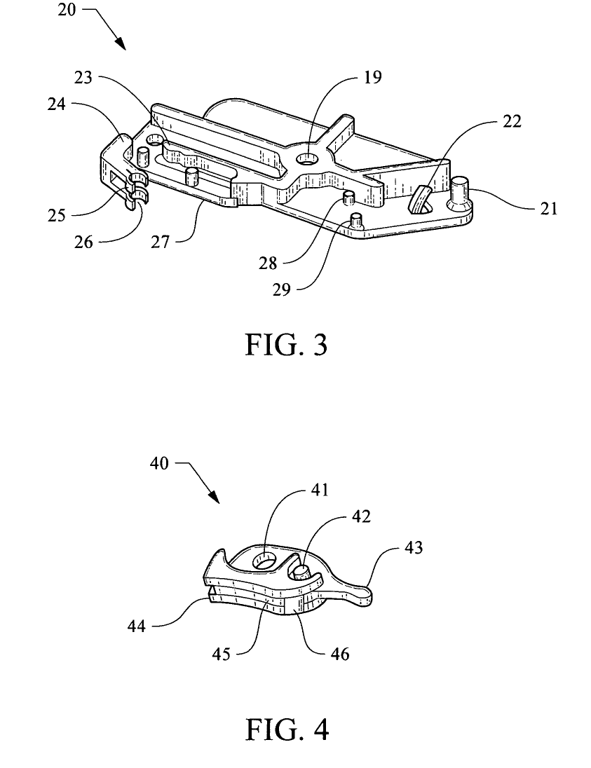

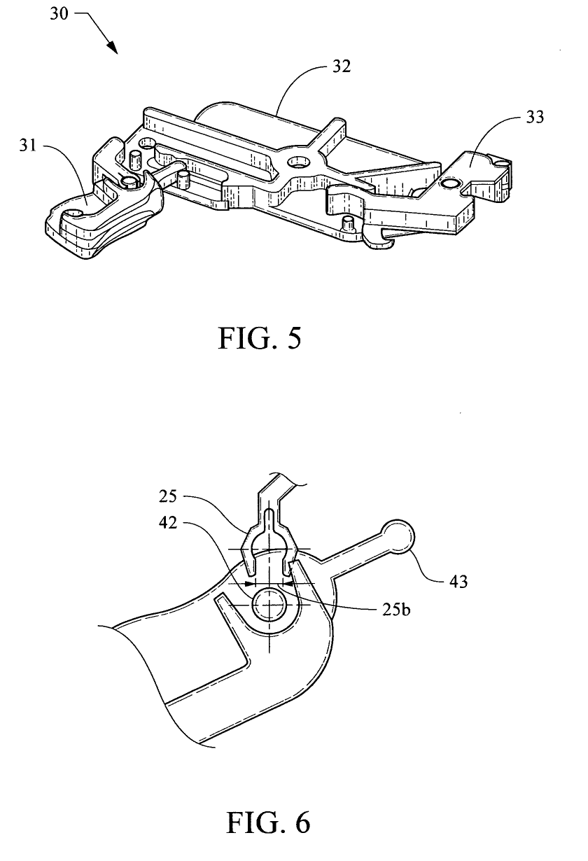

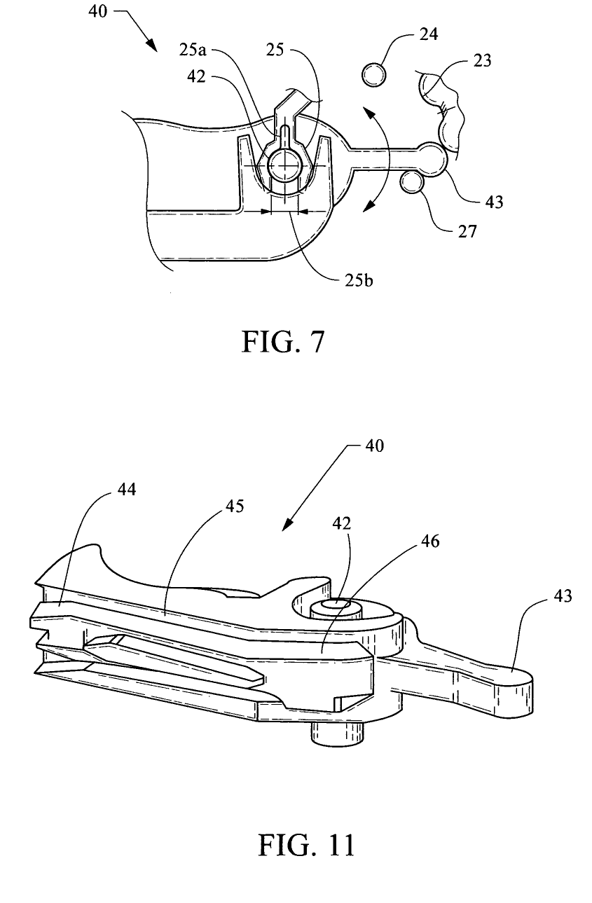

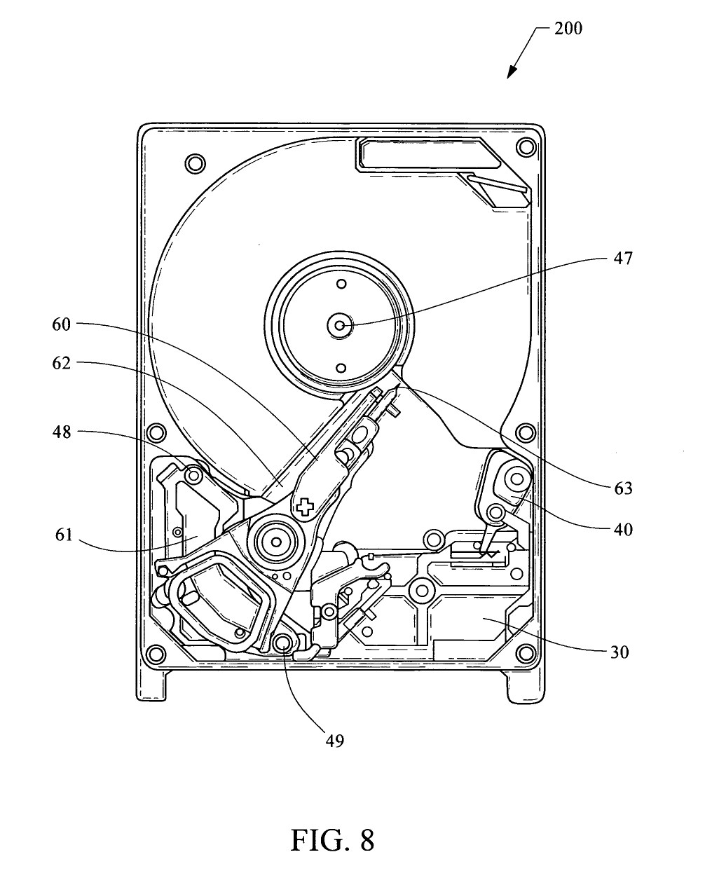

Referring now to FIGS. 3, 4, 6 and 7 showing a perspective view of the connector bracket member 20 and top views of detailed features contained within the connector bracket. The bracket member is designed to minimize material mass yet providing a structured platform to increase mechanical strength and stability. The bracket includes mounting and rotating features for separately attaching and rotating the ramp device 40 during disc assembly. The purpose of rotation is to permit disc assembly space and means to secure the head slider during assembly. Ramp 40, shown in FIG. 4 snaps into a pair of flexure claw members 25, 26 disposed vertically are provided on bracket 20. The claw's openings 25b (best seen in a top view in FIGS. 7 and 8) flexes as a ramp snap post 42 is urged into the claw opening 25b forcing the flexure claw members to spread as the snap post is received into the claw. The interior diameter of the claw, having the same interior diameter as the snap post functions as a journal bearing for snap post 42 therein providing rotational freedom for the ramp. Rotation of the ramp member is limited by stop pins 24 and 27 limiting the ramp's extended member 43 between the two stop pins. Stop pin 27 is the ramp open position during the disc install position. A leaf spring 23 holds the ramp in that position. After the disks have been installed, the ramp 40 is rotated into place over the disc. Pin 24 locates the ramp “in place” position. The same leaf spring 23 keeps the ramp in place against stop pin 24 for fixedly securing the ramp by inserting a screw fastener in mounting hole 41, to secure the ramp to a threaded hole in the base of the hard drive (not shown).

FIG. 4 illustrates a perspective view of the ramp body 40 showing three ramp positions for the head slider. Firstly, the head install position 46, secondly, the head park position 45 and thirdly, the head disk load position 44. Also shown, as previously described, are clearance mounting hole 41, snap post 42, and extended member 43.

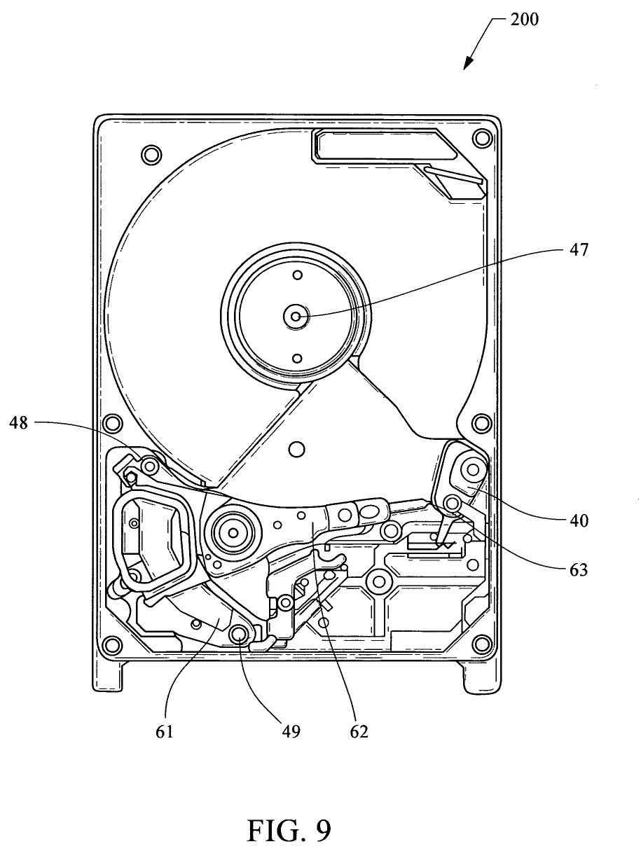

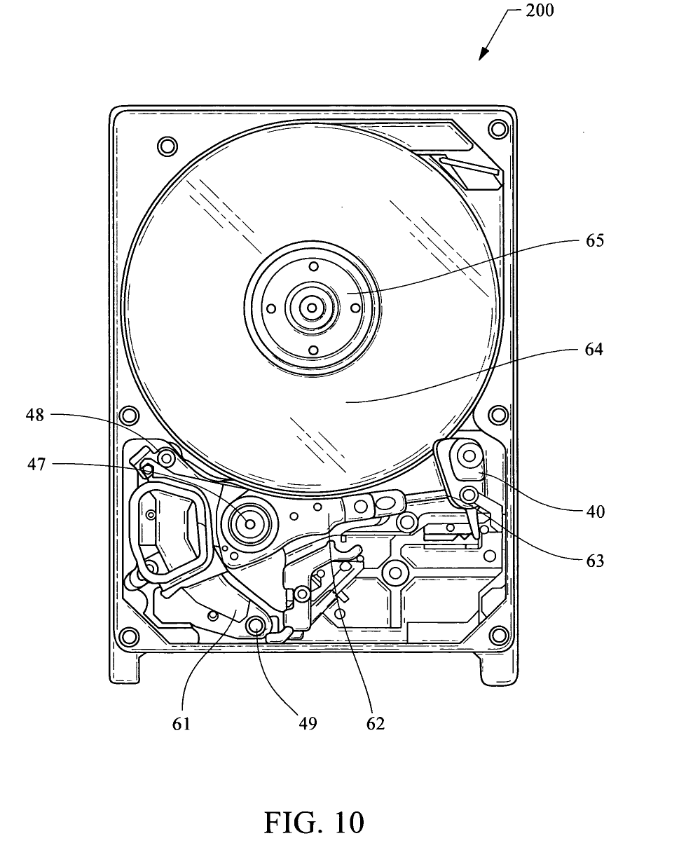

In FIG. 8 illustrating a top view of a hard disc drive assembly 200 without any assembled discs while having a head separator comb 60 in place. The comb is configured for insertion into the actuator 62 and between the head suspensions 63 for protection of the read/write heads during shipping and assembly. The actuator 62, OD and ID stops 48 and 49 respectively, VCM 61 and connector bracket 30 are installed onto the disc drive base. FIGS. 8, 9, and 10 illustrate the extreme positions of the actuator and the read/write head relative to the ramp 40 in the ramp's open and closed positions. Referring also to FIG. 11 showing an enlarged perspective view of ramp 40, illustrating the three ramp positions as the head/disk load slope area 44, the head park position 45 and the extended park position 46. The ramp is designed with a rotational pivot 42 that is aligned comparatively to the actuator pivot 66 while the head 63 in on the ramp's park position. Continuing the ramp park position angularly around the same pivot on the same radius, the read/write heads can be installed from the front (disc) side. Notably, FIG. 8 shows the ramp 40 installed in the open position allowing clearance for disc assembly. In FIG. 9 the actuator 62 is rotated clockwise to the OD park position and against OD stop 48 and on the open ramp position. The read/write head separator comb 60 can be removed and the discs loaded onto spindle 47. FIG. 10 shows the ramp 40 rotated counter-clockwise into the closed position over the disc 64. During the ramp rotation, the read/write heads stay locked against the OD stop as the ramp swings into the final parked position. The advantages of the present invention are as follows:
1) By loading the read/write heads from the front side of the ramp there is not additional travel needed for loading. The front side of the ramp is very traditional, however, the backside has an extended rotational park position that is used to support the heads while the ramp is in the open position before and during disc installation.
2) Provides additional space on the coil side for a more efficient VCM.
3) The OD stop can be assembled before the actuator and discs are installed.
4) The actuator can be installed on the ramp in the park position and the head comb removed before the discs are installed.
5) The only action required after installing the discs is to rotate and to secure the ramp into its safe operating position.
6) There is less possibility for disc damage.
7) The OD stop is fixed to the base for more accurate positioning.
8) Assembly tooling is less complex.

In summary, a method is provided for loading read/write heads, mounted on pivotal actuator arms, onto ramps from the front side of a hard disc drive including the steps of providing a bracket having a ramp pivot bearing for demountably attaching a ramp platform to the bracket and aligning the ramp pivot bearing to the actuator arm pivot, the bracket also having pivoting stops for a ramp locator arm for stopping the ramp in its open and closed positions also providing an extended ramp park position by extending the parking surface angularly around the ramp pivot on the same radius.

The apparatus includes a ramp arrangement to facilitate read/write heads mounted on actuators, to be loaded at the front side in a hard disc drive, the ramp arrangement is composed of a movable ramp to be in either an open or a closed position with a design that has surfaces for ramping, parking and extended parking areas that are selectable for various assembly and disassembly activities. The movable ramp includes a pivot post for pivoting and a locator arm for limiting movement within the open and closed positions. A ramp bracket mounted to a base of a hard disc drive, the bracket having a pivot bearing for demountable attaching the ramp post to the bracket and aligning the ramp pivot bearing to a pivot of the actuator, the bracket also having pivoting stops for the ramp locator arm for stopping the ramp in its open and closed positions;

While the invention has been particularly shown and described with reference to the preferred embodiments thereof, it will be understood by those skilled in the art that various changes in form and details may be made without departing from the spirit and scope of the invention.

What is claimed is:

1. A method of loading read/write heads, mounted on pivotal actuator arms, onto ramps from the front side of a hard disc drive, comprising the steps of:
providing a bracket having a ramp pivot bearing for demountably attaching a ramp to said bracket and aligning said ramp pivot bearing to said actuator pivot, said bracket also having pivoting stops for a ramp locator arm for stopping said ramp in its open and closed positions;
providing an extended ramp park position by extending said parking surface angularly around said ramp pivot on the same radius.

2. The method according to claim 1 wherein said extended ramp park position permits front side loading while in the open ramp position.

3. The method according to claim 1 wherein the actuator, OD and ID stops, and VCM are installed onto the disc drive base with the actuator in a position close to the ID stop.

4. The method according to claim 1 wherein the ramp is installed in the open position.

5. The method according to claim 1 wherein rotating the actuator clockwise to the OD park position and on the open ramp permitting clearance for the read/write head separator comb to be removed.

6. The method according to claim 5 wherein, while in the OD park position and on the open ramp, the discs are loaded onto the spindle and the disc clamp is installed.

7. The method according to claim 1 wherein the ramp is rotated counter-clockwise into the closed position over the disc, the read/write heads stay locked against the OD stop as the ramp swings into the final parked position.

8. The method according to claim 1 wherein by loading the heads from the front side of the ramp, no additional travel is required.

9. The method according to claim 1 wherein more space is available on the coil side to provide a more efficient VCM.

10. The method according to claim 1 wherein the OD stop can be assembled before the actuators and discs are installed.

11. The method according to claim 1 wherein the only action needed after the discs are installed is to rotate and to secure the ramp into position to prevent possibility of disc damage.

12. A ramp arrangement to facilitate read/write heads mounted on actuators, to be loaded at the front side in a hard disc drive, said ramp arrangement comprising:
a movable ramp to either an open or closed position having a configuration that has surfaces for ramping, parking and extended parking areas selectable for various assembly and disassembly activities;
said movable ramp comprises a pivot post for pivoting and a locator arm for limiting movement within said open and closed positions;
a ramp bracket mounted to a base of a hard disc drive, said bracket having a pivot bearing for demountable attaching said ramp post to said bracket and aligning said ramp pivot bearing to a pivot of said actuator, said bracket also having pivoting stops for said ramp locator arm for stopping said ramp in its open and closed positions;
said extended ramp park position extends said parking surface angularly around said ramp pivot on the same radius.

13. The ramp arrangement of claim 12 wherein said extended ramp park position allows front side loading while in the open ramp position, that is, the actuator, OD and ID stops, and VCM are installed onto the disc drive base while the actuator is in a position adjacent to the ID stop.

14. The ramp arrangement of claim 12 wherein the ramp is installed in the open position.

15. The ramp arrangement of claim 12 wherein rotating the actuator clockwise to the OD park position and on the open ramp allows clearance for the read/write head separator comb to be removed.

16. The ramp arrangement of claim 12 wherein, while in the OD park position and on the open ramp, the discs are loaded onto the spindle and the disc clamp is installed.

17. The ramp arrangement of claim 12 wherein the ramp is rotated counter-clockwise into the closed position over the disc, the read/write heads stay locked against the OD stop as the ramp swings into the final parked position.

18. The ramp arrangement of claim 12 wherein by loading the heads from the front side of the ramp, no additional travel is required.

19. The ramp arrangement of claim 12 wherein more space is available on the coil side to provide a more efficient VCM.

20. The ramp arrangement of claim 12 wherein the OD stop can be assembled before the actuators and discs are installed.

21. The ramp arrangement of claim 12 wherein the only action needed after discs are installed is to rotate and to secure the ramp into position to prevent possibility of disc damage.

22. The ramp arrangement of claim 12 wherein disc damage is reduced during assembly and disassembly operations.

23. The ramp arrangement of claim 12 wherein the OD stop is fixed to the base for more accurate positioning.

24. The ramp arrangement of claim 12 wherein assembly tooling is less complex.
